(19) United States
(12) Patent Application Publication
(10) Pub. No.: US 2007/0189649 A1
(43) Pub. Date: Aug. 16, 2007

(54) Lightweight bearing cartridge for wear application

(75) Inventors: Morri Montazeri, Mukilteo, WA (US); Charles T. Bishop, Renton, WA (US)

Correspondence Address: ROBERT R. RICHARDSON, P.S., P.O. BOX 2677, SILVERDALE, WA, 98383-2677, US

(73) Assignee: The Boeing Company

(21) Appl. No.: 11/355,671

(22) Filed: Feb. 16, 2006

(51) Int. Cl. F16C 23/04

(52) U.S. Cl. 384/192

(57) ABSTRACT

Exemplary bearing cartridges are provided. An outer retaining member defines a first curved surface lined with a lubricant. An inner, carburized titanium member is received by the outer retaining member. The inner member defines a second curved surface in sliding contact with the first curved surface. A carburized case extends a predetermined distance from the second curved surface into the inner member. The bearing cartridge may be installed in a housing. The outer retaining member may include a ring defining a concave spherical surface. The inner member may include a ball defining a convex spherical surface. Alternately, the outer retaining member may include a bushing defining a concave cylindrical surface or a spherical ball defining a bore that defines a concave cylindrical surface and the inner member may include a pin defining a convex cylindrical surface. The lubricant may include a polytetrafluroethylene-based lubricant.

### BACKGROUND

Bearing cartridges typically have an outer retaining member that defines a concave spherical or cylindrical surface, or race, that forms a sliding surface and an inner member that defines a convex spherical or cylindrical surface. The outer and inner members typically may be a ring and a ball, or a ball and pin, or a bushing and a pin, all respectively.

In order to decrease sliding friction, the sliding surface of the outer member may be lined with a lubricating liner, such as a polytetrafluoroethylene (PTFE)-based liner like TEFLON® or the like. When the sliding surface is lined with such a liner, the inner member should be made of a material with high hardness and good wear characteristics.

However, materials with high hardness and good wear characteristics currently in use, such as steel, are not lightweight. In certain applications, such as aerospace applications, it is desirable to use lightweight materials.

Titanium is a lightweight material that is widely used in many applications, such as aerospace applications, in which saving weight is a desirable objective. For example, weight of titanium is typically about 0.57 times the weight of steel. However, titanium does not have a surface hardness that provides good wear characteristics.

It would be desirable to fabricate a bearing cartridge using lightweight materials that have good wear characteristics. To that end, attempts have been made to provide titanium with a surface hardness that provides good wear characteristics. These attempts have involved mechanically bonding a surface coating onto the convex spherical surface.

However, a mechanically-bonded surface coating can spall and/or chip. Dislodged particles can then serve as an abrasive, which in turn can tear up the lubricating liner on the concave spherical or cylindrical surface of the outer retaining member, thereby accelerating wear.

It would therefore be desirable to provide a bearing cartridge using lightweight materials that have good wear characteristics without use of mechanically-bonded surface coatings.

The foregoing examples of related art and limitations associated therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems and methods which are meant to be exemplary and illustrative, not limiting in scope. In various embodiments, one or more of the problems described above in the Background have been reduced or eliminated, while other embodiments are directed to other improvements.

In a non-limiting, exemplary bearing cartridge, an outer retaining member defines a first curved surface that is lined with a lubricant, and an inner member that is made of carburized titanium is received by the outer retaining member. The inner member defines a second curved surface that is in sliding contact with the first curved surface of the outer retaining member.

According to an aspect, the outer retaining member may include a ring and the first curved surface may be a concave spherical surface that may include a race, and the inner member may include a ball and the second curved surface may include a convex spherical surface. In such an arrangement, the cartridge may be swaged in a housing with end walls such that the ball is laterally spaced apart from the end walls. In this case, the ball may serve as the outer retaining member and define a bore that defines a concave cylindrical surface that is lined with a lubricant, and a carburized titanium pin or bolt may serve as the inner member and define a convex cylindrical surface that is received by the ball in sliding contact with the concave cylindrical surface of the bore of the ball. Alternately, the cartridge may be swaged in a housing with end walls such that the ball abuts the end walls. In this latter case, the bore of the ball need not be lined with a lubricant.

According to another aspect, the outer retaining member may include a bushing and the first curved surface may be a concave cylindrical surface, and the inner member may include a pin or bolt, such as without limitation a shoulder bolt, and the second curved surface may be a convex cylindrical surface.

According to further aspects, the titanium may include an alloy such as Ti-6Al-4V alloy. Also, the inner member defines a carburized case that extends a predetermined distance from the second curved surface into the inner member. Further, the outer retaining member may be made of one of 15-5 PH CRES, 17-4 PH CRES, and titanium. Moreover, the lubricant may include a polytetrafluroethylene-based lubricant, such as without limitation TEFLON®.

In addition to the exemplary embodiments and aspects described above, further embodiments and aspects will become apparent by reference to the drawings and by study of the following detailed description.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view of an exemplary bearing cartridge;

FIG. 2A is a cutaway side view of an exemplary bearing cartridge in a housing;

FIG. 2B is a cutaway side view of another exemplary bearing cartridge in a housing; and

FIG. 3 is a cutaway side view of yet another exemplary bearing cartridge in a housing.

### DETAILED DESCRIPTION

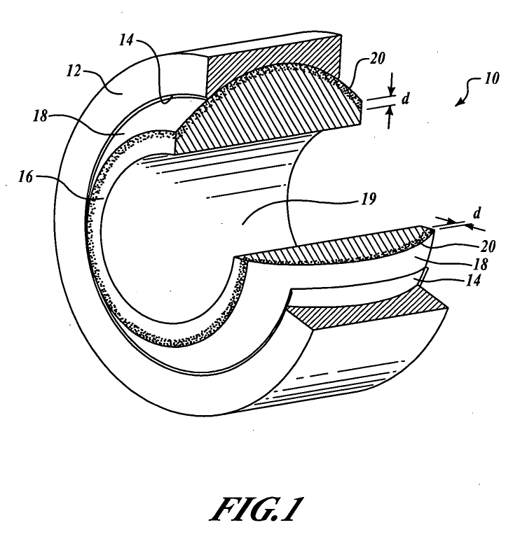

By way of overview and referring to FIG. 1, in a non-limiting, exemplary bearing cartridge 10 an outer retaining member 12 defines a curved surface 14 that is lined with a lubricant, and an inner member 16 that is made of carburized titanium is received by the outer retaining member 12. The inner member 16 defines a curved surface 18 that is in sliding contact with the curved surface 14. Details of exemplary embodiments will now be set forth below.

In some embodiments, and as shown in FIG. 1, the outer retaining member 12 suitably is a ring. In these embodiments, the curved surface 14 suitably is a concave spherical surface, such as a race. In other embodiments (that will be discussed below) the outer retaining member 12 suitably is a bushing, and the curved surface 14 suitably is a concave cylindrical surface. The curved surface 14 defines a sliding surface. The outer retaining member 12 may be made of steel, such as without limitation precipitation hardened steel like 15-5 PH CRES or 17-4 PH CRES. Alternately, if desired to reduce weight, the outer retaining member 12 may be made of titanium, such as without limitation a titanium alloy like Ti-6Al-4V or Ti-3.0Al-2.5V.

In some embodiments, and as shown in FIG. 1, the inner member 16 suitably is a ball. In these embodiments, the curved surface 18 suitably is a convex spherical surface. As an overview of other embodiments (that will be discussed below), the ball defines a bore that defines a concave cylindrical surface 19 that may be lined with a lubricant and that receives in sliding contact therein a carburized titanium pin or bolt (not shown). In such an arrangement, the ball may be considered the outer retaining member and the pin or bolt (not shown) may be considered the inner member. In yet other embodiments (that will be discussed below), the inner member 16 suitably is a pin or bolt, such as a shoulder bolt or the like, and the curved surface 18 suitably is a convex cylindrical surface. In all embodiments, the curved surface 18 of the inner member 16 is received by the outer retaining member 12 in sliding contact with the curved surface 14 of the outer retaining member 12. To reduce sliding friction between the sliding surface of the curved surface 14 and the curved surface 18, the curved surface 14 of the outer retaining member 12 suitably is lined (or coated) with a lubricant liner. Exemplary lubricants include polytetrafluroethylene (PTFE)-based lubricants, such as without limitation TEFLON®, available from E.I. du Pont de Nemours and Company of Wilmington, Del.

Advantageously, the inner member 16 is made of carburized titanium. Use of carburized titanium for the inner member 16 imparts lightweight titanium with a surface hardness that provides good wear characteristics. Moreover, such desirable surface hardness is provided without use of a mechanically-bonded surface coating.

Without limitation, titanium or a titanium alloy such as Ti-6Al-4V is made into a part having the desired shape of the inner member 16. The titanium part is carburized in a known manner. A diffused, carburizing treatment for titanium that has been found to be especially well suited for treating the inner member 16 is plasma carburizing treatment (PCT). Details of the PCT process are described in U.S. Pat. No. 5,466,305 entitled “Method of Treating the Surface of Titanium” and assigned to Tanaka Limited of Osaka, Japan, the entire contents of which are incorporated by reference.

Using the PCT process, the curved surface 18 of the titanium part for the inner member 16 is treated to reduce the friction coefficient and wear loss without sacrificing its corrosion resistance. The titanium part is subjected to plasma-carburizing in an atmosphere containing hydrocarbon gas at a pressure between 0.5 Torr and 15 Torr and a temperature between 700 degrees Centigrade and 1,100 degrees Centigrade. In an especially advantageous process, the titanium part is plasma-carburized at a temperature that is low enough so strength of the titanium is not detrimentally affected. That is, any aluminum (Al) or vanadium (V) that may be present in a titanium alloy will not be put into solution at such temperatures.

As a result of diffused carburizing, a diffused carburized case 20 of desired hardness extends a depth d from the curved surface 18 into the inner member 16. The case 20 includes carbon in the form of carbon and/or carbides. Average Vickers hardness exhibited on the curved surface 18 and in the case 20 suitably is 420 HV0.1, 0.98N and 499 HV0.025, 0.24N. The depth d suitably is in a range between around 0.0002 inch (0.2 mil) to around 0.0005 inch (0.5 mil), as desired for a particular application. In one exemplary application, the depth d is around 0.2 mil. The depth d is thus shallow enough so deflections do not damage the case 20, thereby providing some flexibility.

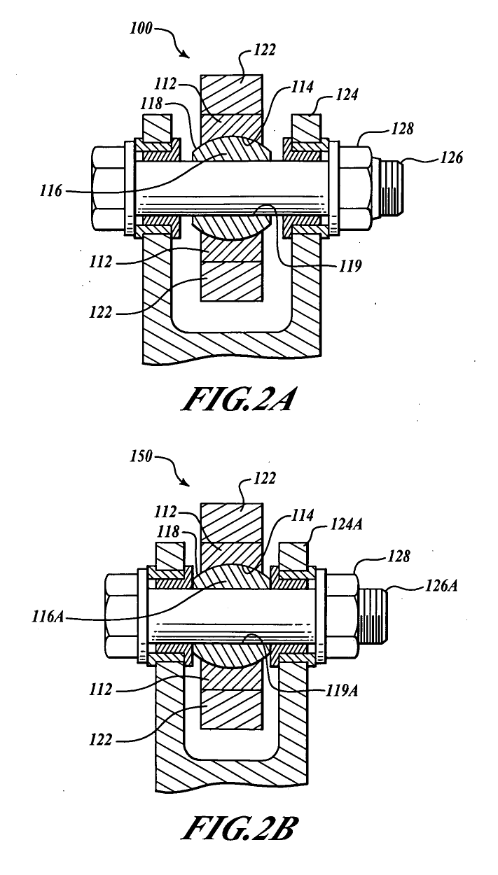

The bearing cartridge 10 may be swaged in various housings as desired to provide exemplary bearings. For example and referring now to FIG. 2A, an exemplary bearing 100 is an unclamped joint. The outer retaining member is a ring 112 that defines a concave spherical surface 114, such as a ring or the like, that is lined with a lubricant, such as a PTFE-based lubricant liner, as described above. The ring 112 is made of materials described above for the outer retaining member 12 (FIG. 1). The inner member is a ball 116 that defines a convex spherical surface 118. Advantageously, in addition to the concave spherical surface 114 being lined with the lubricant, the bore of the ball 116 defines a concave cylindrical surface 119 that also is lined with the lubricant. The ball 116 is received in the ring 112 as described above.

The ring 112 and the ball 116 are swaged into a housing that includes a lug 122 and a clevis 124. End walls of the clevis 124 are laterally spaced apart from ball 116. A carburized, titanium pin or bolt 126 is received inside the bore of the ball 116. Thus, a convex cylindrical surface of the carburized titanium pin or bolt 126 slides against the lubricant liner on the concave cylindrical surface 119. In such an arrangement, the ball 116 may be considered the outer retaining member and the pin or bolt 126 may be considered the inner member. The pin or bolt 126 is secured against an exterior of the clevis 124 with a nut 128.

The bearing 100 allows joint misalignment from a plane perpendicular to an axis of rotation of the ball 116 in an unclamped application that allows movement of the carburized titanium pin or bolt 126 in the bore of the ball 116. Relative motion may occur between the ring 112 and the ball 116 and between the ball 116 and the pin or bolt 126. In the exemplary bearing 100, the load-carrying capability is limited by the lubricant liner on the bore of the ball 116. The bearing 100 can carry the same load and can withstand a temperature of 320 degrees Fahrenheit as can a conventional spherical, lined bearing with a ball made of 440C CRES. However, the bearing 100 provides substantial weight savings over a conventional spherical, lined bearing with a ball made of 440C CRES. The bearing 100 thus is well-suited for lightweight applications that are not exposed to contamination such as dirt, sand, and debris. Examples of suitable applications include, but are not limited to, aerospace interior applications, such as supporting aircraft interior components such as stow bins.

Referring now to FIG. 2B, a bearing 150 is a clamped joint. The bearing 150 includes the ring 112 with the concave spherical surface 114 that is lined with the lubricant as described above for the bearing 100 (FIG. 2A). However, the bearing 150 includes a ball 116A that defines the convex spherical surface 118 and that defines a bore that defines a concave cylindrical surface 119A that is not lined with a lubricant. The ring 112 and the ball 116A are swaged in a housing that includes the lug 122 and a clevis 124A with endwalls that abut sides of the ball 116A. A pin or bolt 126A that may be made of titanium but need not be carburized is received within the bore of the ball 116A and is secured against the clevis 124A with the nut 128. Because the ball 116A is clamped against the clevis 124A, movement of the pin or bolt 126A in the bore of the ball 116A is prevented. Because the spherical surface of the ball 116A has a greater surface area than does the cylindrical surface 119 (FIG. 2A), load-carrying capability of the clamped bearing cartridge 150 is greater than that for the unclamped bearing cartridge 100 (FIG. 2A). The bearing 150 is also well-suited for lightweight applications that are not exposed to contamination such as dirt, sand, and debris, such as without limitations aircraft interior applications.

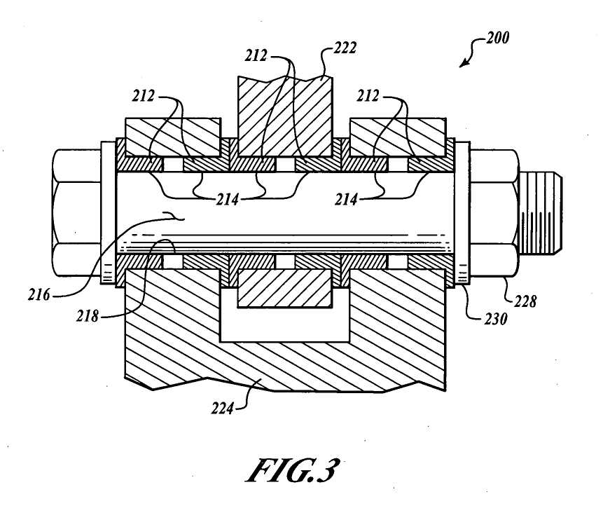

Referring now to FIG. 3, a bearing 200 includes an outer retaining member that is a bushing 212 that defines a concave cylindrical surface 214 that is lined with a lubricant, such as without limitation a PTFE-based lubricant liner. The bushing 212 is installed in a housing that includes a lug 222 and a clevis 224. A carburized, titanium pin or bolt 216 (made from titanium, such as Ti-6Al-4V or Ti-5Al-5V-5Mo-3Cr, that has been carburized as described above) provides the inner member for the bearing 200. The pin or bolt 216 defines a convex cylindrical surface 218 that is in sliding contact with the concave cylindrical surface 214. A washer 230 is placed against the exterior of the clevis 224, and a nut 228 is tightened against the washer 230 to secure the pin or bolt 216. Thus, the bearing 200 provides a non-self-aligning, unclamped joint in which the pin or bolt 216 can rotate in the bushing 212. The load-carrying capability of the bearing 200 is limited by the lubricant liner on the bushing 212, as described above for the bearing 100 (FIG. 2A). Notwithstanding, the carburized, titanium pin or bolt 216 can replace pins made from heavier 52100 alloy steel, 440C CRES, and 15-5 PH CRES, thereby providing significant weight savings.

The bearing 200 (along with conventional bearings) was wear tested, and advantageously showed no appreciable wear after being subjected to a radial stress of 40 ksi for 100,000 cycles of +/−25 degrees oscillation. Results of the wear testing are shown in Table 1.

TABLE 1

| | | | At 25,000 | | At 50,000 | | At 75,000 | | At 100,000 | |
|---|---|---|---|---|---|---|---|---|---|---|
| | At Zero | | Cycles | | Cycles | | Cycles | | Cycles | |
| 1) Pin Identification | Cycle | | Bushing | Pin | Bushing | Pin | Bushing | Pin | Bushing | Pin |
| 2) Material | Bushing | Pin | wear | Wear | Wear | Wear | Wear | Wear | Wear | wear |
| 3) Surface finish | ID | Dia | inch | Inch | inch | inch | inch | inch | inch | inch |
| 1) HRC 50 | .87495 | .8723 | .00005 | .0000 | .00055 | .0000 | .0020 | .0000 | .0030 | .0000 |
| 2) Carbon Steel | | | Max. temp: | | Max. temp: | | Max. temp: | | Max. temp: | |
| 3) None | | | 95 F. | | 98.4 F. | | 100 F. | | 101.8 F. | |
| 1) 440C-1 | .8770 | .8735 | .00006 | .0000 | .00006 | .0000 | .0010 | .0000 | .0012 | .0000 |
| 2) 440C stainless | | | Max. temp: | | Max. temp: | | Max. temp: | | Max. temp: | |
| 3) None | | | 99.4 F. | | 103.6 F. | | 105.6 F. | | 105.1 F. | |
| 1) 440C-2 | .8750 | .8737 | .0005 | .0000 | .0015 | .0000 | .0020 | .0000 | .0025 | .0000 |
| 2) 440C stainless | | | Max. temp: | | Max. temp: | | Max. temp: | | Max. temp: | |
| 3) None | | | 106.5 F. | | 108 F. | | 112 F. | | 114.2 F. | |
| 1) Ti-1 | .8750 | .8738 | Damaged | Damaged | AT 28,900 CYCLES PIN | | | | | |
| 2) Titanium 6Al—4V | | | liner | Pin | GALLED stopped the test | | | | | |
| 3) None | | | Max. temp: 155.4 F. | | Max. temp: | | Max. temp: | | Max. temp: | |
| 1) Ti-2 | .8750 | .8739 | AT 21,308 CYCLES PIN GALLED AND | | | | | | | |
| 2) Titanium 6Al—4V | | | LINER THICKNESS WORN OUT COMPLETELY | | | | | | | |
| 3) None (Rev. A) | | | Max. temp: 180.4 F. | | Max. temp: | | Max. temp: | | Max. temp: | |
| 1) Ti-5 | .8750 | .8735 | .002 | .0000 | .0025 | .0000 | .0030 | .0000 | .0038 | .0000 |
| 2) Titanium 6Al—4V | | | | | | | | | | |

| | | | | |
|---|---|---|---|---|
| 3) PCT | Max. temp: | Max. temp: | Max. temp: | Max. temp: |
| | 111.3 F. | 112.9 F. | 114.8 F. | 115.3 |

| 1) Ti-3 | .8750 | .8735 | .003 | 0.000 |
|---|---|---|---|---|
| 2) Titanium 6Al—4V | | | Max. temp: | |
| 3) PCT | | | 140 F. | |
| 1) Ti-7 | .8760 | .8735 | .002 | 0.000 |
| 2) Titanium 6Al—4V | | | Max. temp: | |
| 3) PCT | | | 131 F. | |
| 1) Ti-9 | .8750 | .8735 | .002 | 0.0001 |

| | |
|---|---|
| 2) Titanium 6Al—4V | Max. temp: |
| 3) PCT | 144 F. |

While a number of exemplary embodiments and aspects have been illustrated and discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

What is claimed is:

1. A bearing cartridge comprising:
an outer retaining member that defines a first curved surface that is lined with a lubricant; and
an inner member that is received by the outer retaining member, the inner member defining a second curved surface that is in sliding contact with the first curved surface, the inner member being made of carburized titanium.

2. The bearing cartridge of claim 1, wherein:
the outer retaining member includes a ring and the first curved surface includes a concave spherical surface; and
the inner member includes a ball and the second curved surface includes a convex spherical surface.

3. The bearing cartridge of claim 2, wherein the cartridge is swaged in a housing with end walls such that the ball is laterally spaced apart from the end walls.

4. The bearing cartridge of claim 3, wherein the ball defines a bore that defines a concave cylindrical surface that is lined with a lubricant, and a carburized titanium pin is received by the ball in sliding contact with the concave cylindrical surface.

5. The bearing cartridge of claim 2, wherein the cartridge is swaged in a housing with end walls such that the ball abuts the end walls.

6. The bearing cartridge of claim 1, wherein:
the outer retaining member includes a bushing; and
the inner member includes a pin.

7. The bearing cartridge of claim 1, wherein:
the outer retaining member includes a spherical ball that defines a bore that defines the first curved surface; and
the inner member includes a pin.

8. The bearing cartridge of claim 1, wherein the titanium includes Ti-6Al-4V titanium alloy.

9. The bearing cartridge of claim 1, wherein the outer retaining member is made of one of 15-5 PH CRES, 17-4 PH CRES, and titanium.

10. The bearing cartridge of claim 1, wherein the inner member defines a carburized case that extends a predetermined distance from the second curved surface into the inner member.

11. The bearing cartridge of claim 1, wherein the lubricant includes a polytetrafluroethylene-based lubricant.

12. A bearing cartridge comprising:
an outer retaining ring that defines a concave spherical surface that is lined with a lubricant; and
an inner ball that is received by the outer retaining ring, the inner ball defining a convex spherical surface that is in sliding contact with the concave spherical surface, the inner ball being made of carburized titanium that defines a carburized case that extends a predetermined distance from the convex spherical surface into the inner ball.

13. The bearing cartridge of claim 12, wherein the cartridge is swaged in a housing with end walls such that the ball is laterally spaced apart from the end walls.

14. The bearing cartridge of claim 13, wherein the ball defines a concave cylindrical surface that is lined with a lubricant, and a carburized titanium pin is received by the ball in sliding contact with the concave cylindrical surface.

15. The bearing cartridge of claim 12, wherein the cartridge is swaged in a housing with end walls such that the ball abuts the end walls.

16. The bearing cartridge of claim 12, wherein the titanium includes Ti-6Al-4V titanium alloy.

17. The bearing cartridge of claim 12, wherein the outer retaining ring is made of one of 15-5 PH CRES, 17-4 PH CRES, and titanium.

18. The bearing cartridge of claim 12, wherein the lubricant includes a polytetrafluroethylene-based lubricant.

19. A bearing cartridge comprising:
an outer retaining member that defines a concave cylindrical surface that is lined with a lubricant; and
an inner pin that is received by the outer retaining member, the inner pin defining a convex cylindrical surface that is in sliding contact with the concave cylindrical surface, the inner pin being made of carburized titanium that defines a carburized case that extends a predetermined distance from the convex cylindrical surface into the inner pin.

20. The bearing cartridge of claim 19, wherein the outer retaining member includes one of a bushing and a spherical ball.

21. The bearing cartridge of claim 19, wherein the titanium includes Ti-6Al-4V titanium alloy.

22. The bearing cartridge of claim 19, wherein the outer retaining bushing is made of one of 15-5 PH CRES, 17-4 PH CRES, and titanium.

23. The bearing cartridge of claim 19, wherein the lubricant includes a polytetrafluroethylene-based lubricant.

24. A bearing cartridge made according to a process that comprises:
providing an outer retaining member that defines a first curved surface;
lining the first curved surface with a lubricant;
carburizing an inner member that is made of titanium, the inner member defining a second curved surface; and
receiving the inner member in the outer retaining member such that the second curved surface is in sliding contact with the first curved surface.

25. The bearing cartridge of claim 24, wherein carburizing includes plasma carburizing treatment.

26. The bearing cartridge of claim 24, wherein carburizing defines a carburized case that extends a predetermined distance from the second curved surface into the inner member.

27. The bearing cartridge of claim 24, wherein the lubricant includes a polytetrafluroethylene-based lubricant.

28. The bearing cartridge of claim 24, wherein the process further comprises installing the cartridge in a housing.
